(19) United States
(12) Patent Application Publication
(10) Pub. No.: US 2015/0264345 A1
(43) Pub. Date: Sep. 17, 2015

(54) Method for Coding Videos and Pictures Using Independent Uniform Prediction Mode

(71) Applicant: Mitsubishi Electric Research Laboratories, Inc., Cambridge, MA (US)

(72) Inventors: Robert A. Cohen, Somerville, MA (US); Xingyu Zhang, Cambridge, MA (US); Anthony Vetro, Arlington, MA (US)

(73) Assignee: Mitsubishi Electric Research Laboratories, Inc., Cambridge, MA (US)

(21) Appl. No.: 14/207,871

(22) Filed: Mar. 13, 2014

(51) Int. Cl. H04N 19/103; H04N 19/176

(52) U.S. Cl. CPC H04N 19/103; H04N 19/176

(57) ABSTRACT

A method for decoding a bitstream, including compressed pictures of a video, wherein each picture includes one or more slices, wherein each slice includes one or more blocks of pixels, and each pixel has a value corresponding to a color, for each slice, first obtains a reduced number of colors corresponding to the slice, wherein each color is represented as a color triplet and the reduced number of colors is less than or equal to a number of colors in the slice. Then, for each block, a prediction mode is determined, wherein an independent uniform prediction mode is included in a candidate set of prediction modes. For each block, a predictor block is generated, wherein all values of the predictor block have a uniform value according to a color index when the prediction mode is set as the independent uniform prediction mode. Lastly, the predictor block is added to a reconstructed residue block to form a decoded block as output.

### FIELD OF THE INVENTION

The invention relates generally to coding pictures and videos, and more particularly to methods for predicting pixel values of parts of the pictures and videos in the context of encoding and decoding screen content pictures and videos.

### BACKGROUND OF THE INVENTION

Due to rapidly growing video applications, screen content coding has received much interest from academia and industry in recent years. The screen-content video signal contains a mix of camera-acquired natural videos, images, computer-generated graphics, and text. Such type of video signals are widely used in the applications like wireless display, tablets as second display, control rooms with high resolution display wall, digital operating room (DiOR), screen/desktop sharing and collaboration, cloud computing, gaming, automotive/navigation display, remote sensing, etc.

The High Efficiency Video Coding (HEVC) standard is jointly developed by International Telecommunication Union (ITU)-T and International Organization for Standardization (ISO) and the International Electrotechnical Commission (IEC). HEVC improves the compression efficiency by doubling the data compression ratio compared to H.264. However, HEVC has been designed mainly for videos acquired by cameras form natural scenes. However, the properties of computer generated graphics are quite different from those of natural content. HEVC currently does not fully exploit these properties. Thus, there is a need to improve the coding of such mixed content in videos.

During the development process of HEVC and its extensions, there were also some proposals about improving the coding efficiency of screen content video. The common deficiencies of those methods are their complexity, lack of suitability for a parallelized implementation, and the need to signal significant amounts of overhead information in order to code a block.

### SUMMARY OF THE INVENTION

This invention provides a method for coding pictures in videos using an independent uniform prediction mode into a bitstream. A predictor block is generated to predict the coding blocks in the pictures. The predictive pixel values in the predictor block can be decoded or inferred from the bitstream and can be independent of neighboring reconstructed pixels.

When the independent uniform prediction mode is used, the predicted pixel value for each color component of the block can be different.

Flags or additional bits are signaled in the bitstream to indicate the selection of the independent uniform prediction mode and corresponding parameters.

Using the methods described for the embodiments of the invention, all pixels within a block can be predicted at the same time, because an independently-computed uniform predictor is used. Moreover, there is no the dependency of neighboring reconstructed pixel at the decoder.

### BRIEF DESCRIPTION OF THE DRAWINGS

FIG. 1 is flow diagram of decoding parameter TotalColorNo and parameter ColorTriplet[j][c] at slice header according to embodiments of the invention;

FIG. 2 is flow diagram of decoding a CU block under the independent uniform prediction mode according to embodiments of the invention;

FIG. 3 is block diagram of an exemplar decoder and decoder according to embodiments of the invention; and

FIG. 4 is flow diagram for computing and signaling the parameter TotalColorNo and the dominant colors according to embodiments of the invention.

### DETAILED DESCRIPTION OF THE PREFERRED EMBODIMENTS

The embodiments of our invention provide a method for coding pictures using an independent uniform prediction mode. Coding can comprise encoding and decoding. Generally, the encoding and decoding are performed in a codec (CODer-DECcoder. The codec is a hardware device, firmware, or computer program capable of encoding and/or decoding a digital data stream or signal. For example, the coder encodes a bitstream or signal for compression, transmission, storage or encryption, and the decoder decodes the encoded bitstream for playback or editing.

The method predicts a coding region of the coding pictures using a predictor block, where all predictive pixels at different locations within this block are identical. The color components of a predictive pixel do not necessary have the same color value. The value of the predictive pixels can be independent of neighboring reconstructed pixels of the coding region. Such a coding region is not limited to be a coding unit (CU), prediction unit (PU), or transform unit (TU). Other shapes or sizes of the coding region are also possible.

Coding System

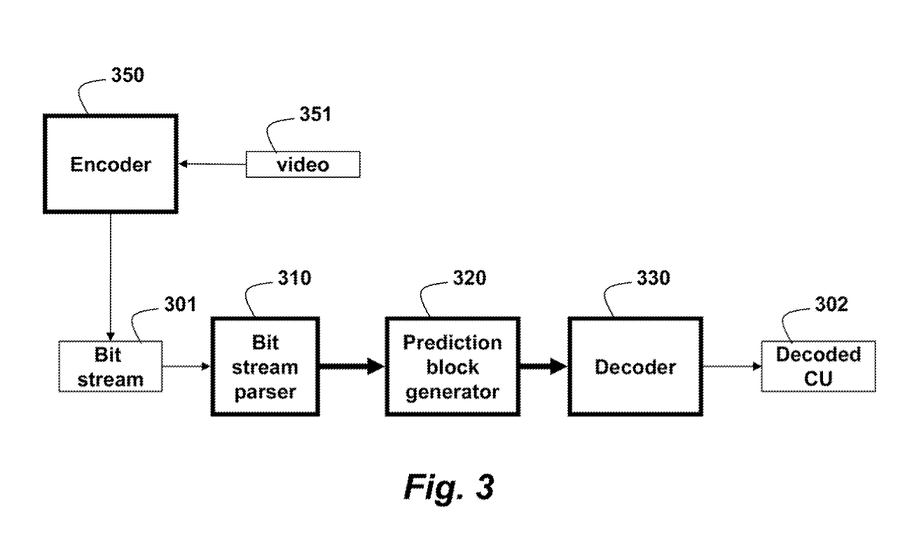

FIG. 3 show an example encoder, decoder and method used by embodiments of the invention, i.e., the steps of the method are performed by the decoder, which can be software, firmware or a processor connected to a memory and input/output interfaces by buses as known in the art. It is understood that the steps can also be similarly performed

Input to the method (or decoder) is a bitstream 301 of coded pictures, e.g., an image or a sequence of images in a compressed video. The bitstream is parsed 310 to obtain a mode index and parameters for generating a prediction mode of the current block.

When the mode index indicates using the independent uniform prediction mode, an independent predictor block is generated 320 for predicting the current block. When the mode index indicates other prediction mode, a predictor block is generated under other conventional prediction modes. The pixel value of the independent predictor block can be selected from one or more than one candidate pixel values. Then, the current block can be decoded 330 as a CU 302, as described in further detail below.

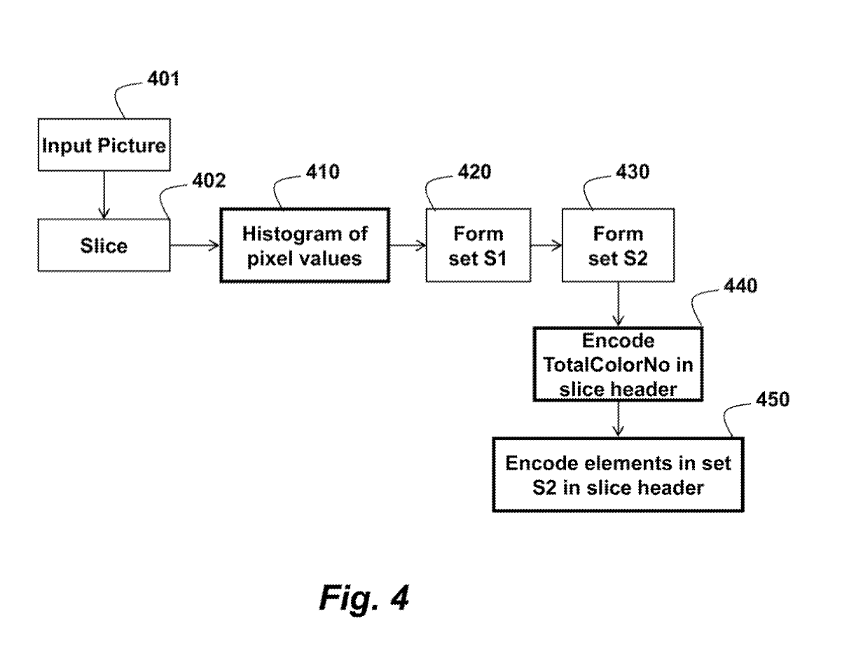

The encoder 350 receives the video 351 to be compressed and outputs the bitstream 301. The encoder operates in a similar manner as the decoder, as would be understood by one of ordinary skill in the art. The details of the encoder as they relate to the embodiments of the invention are described below with reference to FIG. 4

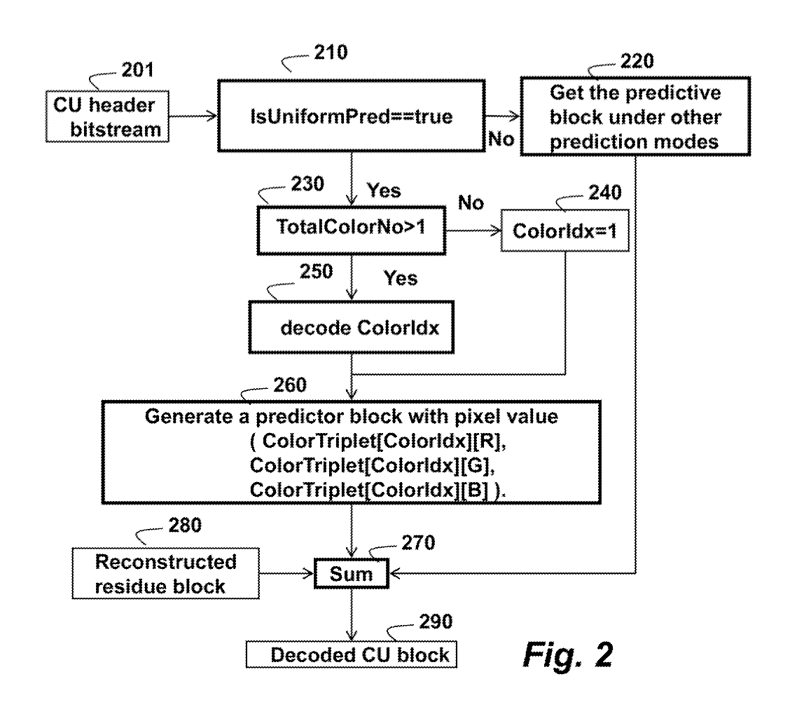

As shown in FIG. 2, a total number of colors, i.e., candidate pixel values, is indicated by the parameter TotalColorNo. The pixel value used in generating the predictor block is determined by the parameter ColorIdx.

A reconstructed residue block decoded 280 from the bitstream is added in a summation process 270 to the generated independent predictor block to produce the reconstructed block for the current block 290.

Various embodiments are now described.

### Embodiment 1

Video signals often comprise three color components, e.g., RGB or YCbCr. For an N×N block, the block size of the three color components can be the same or different. In the 4:4:4 format video signal, each pixel within the block contains three component values, R, G, and B. The R block, G block and B block of an N×N block are of the same size. For simplicity, a 4:4:4 format RGB video signal is used for illustration purposes in the following description. Similar steps can extend this method to other video signal formats.

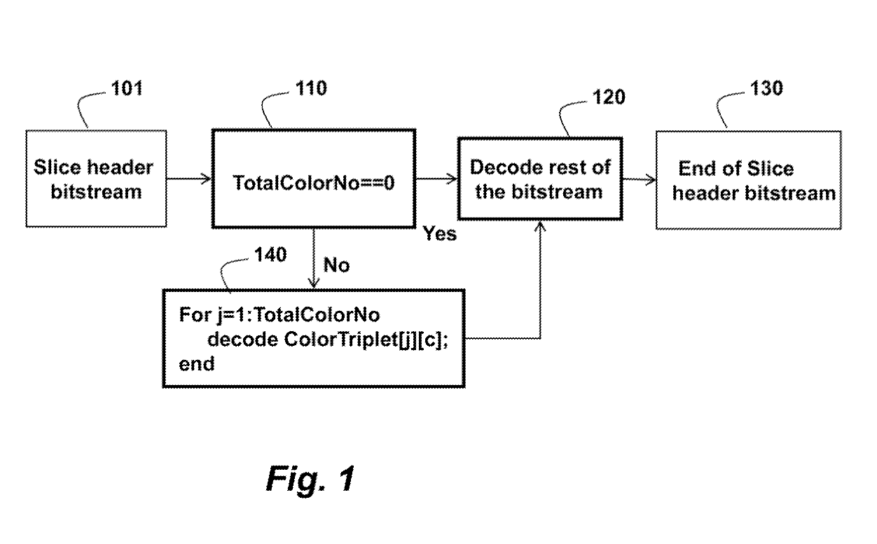

FIG. 1 is diagram of the decoding process for the parameter TotalColorNo and parameter ColorTriplet[j][c] at a slice header in a slice header bitstream 101. A slice, which is a portion or all of a picture, contains one or more blocks such as coding tree blocks or coding units.

The input 101 is the bitstream representing the coded video. For each picture, picture header information, slice header information, CU header information, PU level information, TU level information, etc., is read and decoded from the bitstream sequentially. In the slice header information, a parameter TotalColorNo is decoded. In decision block 110, if TotalColorNo=0, the independent uniform prediction mode is not be used in the corresponding slice, and the rest of the bitstream is decoded 120 to generate the end slice header 130.

If TotalColorNo=k, where k>0, then the independent uniform prediction mode slice has k candidate pixel values for generating predictor block predictors in the corresponding slice.

When TotalColorNo=k and k>0, k sets of pixel value are be decoded 140 from the bitstream from the slice header. A set of pixel value is the triplet ColorTriplet[j][c], or set of three numbers, which corresponds to the value of R, G and B components of a pixel.

Some embodiments can have more or less than three components, or the embodiments can arrange the components in a different order. The j^{th} set of pixel values is a triplet which can be represented by the parameter ColorTriplet[j][c], where j ε[1, k] and cε{R, G, B}.

When TotalColorNo=0, pixel values are not decoded in this step.

In addition of decoding the parameters TotalColorNo and ColorTriplet[j][c] from the slice header, the parameters y can also be decoded from the sequence header, picture header or CU header, etc.

Decoding 300

As shown in the CU bitstream decoding process of FIG. 2, in the CU header information 201, a flag IsUnifromPred is decoded 210. If the flag IsUniformPred is false, then the current CU is decoded 220 according to any other conventional prediction modes. If the flag IsUniformPred is true, then the current CU is be decoded by the independent uniform prediction mode according to embodiments of the invention.

When TotalColorNo=0, the flag of IsUniformPred is absent from the bitstream and the CU is decoded by other conventional prediction modes, rather than the independent uniform prediction mode according to the embodiments.

If IsUniformPred is true, the parameter ColorIdx is decoded 250 from the CU header. The prediction of a CU block of size N×N is a predictor block in which all the pixel values have the color (ColorTriplet[ColorIdx][R], ColorTriplet[ColorIdx][G], ColorTriplet[ColorIdx][B]) as generated in block 260.

If TotalColorNo=1, the parameter ColorIdx is not decoded. In this case, the parameter ColorIdx is inferred 240 to be 1.

In addition to the flag IsUniformPred and parameter ColorIdx being present in the CU header, the flag and parameter can also be present at the PU level, TU level or other defined block levels in the bitstream. In those cases, the predictor blocks for prediction have the same size as the defined block.

A decoded CU 290 is be reconstructed by adding 270 the predictor block with the reconstructed residue block 280.

### Embodiment 2

In this embodiment, the bits for parameter TotalColorNo are absent from the input bitstream 101, and the parameter TotalColorNo is set to a predefined default value in the encoder and the decoder.

### Embodiment 3

In this embodiment, the set of pixel values is not decoded from the bitstream 101, and parameter ColorTriplet[j][c] uses predefined values set in the encoder and decoder. An example of this case is ColorTriplet[1][R,G,B]=(0, 0, 0) and ColorTriplet[2][R,G,B]=(255, 255, 255).

### Embodiment 4

In this embodiment, Embodiments 2 and 3 are combined, so that both TotalColorNo and ColorTriplet are predefined.

### Embodiment 5

In this embodiment, (ColorTriplet[ColorIdx][R], ColorTriplet[ColorIdx][G], ColorTriplet[ColorIdx][B])=(0, 0, 0). In this case, no predictor block is formed for the prediction, and the reconstructed residue block 280 is output as the decoded CU block without going through the summation process 290.

### Embodiment 6

If TotalColorNo=1, the parameter ColorIdx is decoded from the bitstream. Typically, the decoded value is equal to 1.

### Embodiment 7

In this embodiment, N₀ color triplets are predefined at both the encoder and the decoder. Only (TotalColorNo—N₀) color triplets are decoded from the bitstream. For example, if N₀=2, then the predefined color triplets are (0,0,0) and (255, 255, 255), and only (TotalColorNo—N₀) additional color triplets are decoded. In a variation of this embodiment, one or more triplets that were used in the previously-coded slice are considered as being the predefined triplets. For example, the color triplet that is used most frequently when encoding or decoding the previous slice can be used as the predefined triplet.

### Embodiment 8

In this embodiment, the processing steps of the encoder are described. The possible decoding process can be referred from embodiment 1 to embodiment 6.

Step 1: As shown in FIG. 4, the input is a picture 401 of the video 351 to be encoded. The input picture contains one or more slices 402. For each slice, the dominant colors of the slice are estimated. The slice is partitioned into non-overlapped M×M blocks, and a histogram of pixel values is generated 410.

The total number of the M×M blocks inside the slice is denoted as R₁. The value of the pixel, which locates at the top-left corner inside the j^{th} M×M block, is denoted as P₀(j). The top K most frequently used values of P₀(i)ε[1, R] are selected and form 420 a set S₁. Each element of set S₁ is a color triplet. A set S₂ is also formed 430, where S₂ is similar to S₁, except for the fact that the element(s) having a frequency of usage less than threshold T₁ is(are) excluded. The values of parameter K and threshold T₁ are predefined.

Step 2: The value of parameter TotalColorNo is set to be the number of elements in set S₂. Parameter TotalColorNo is set 450 in the slice header. The elements of set S₂ are signaled in the bitstream 301 sequentially thereafter.

When the parameter TotalColorNo is zero, elements of the set S₂ are absent in the bitstream 301.

Step 3: For each CU, a rate distortion optimization (RDO) process is used to select the best prediction mode. This RDO technique is a commonly used technique in video codecs. When the independent uniform prediction mode is selected, one of the element from set S₂ is used to form a predictor block of the same size as the CU to predict the current CU. The index of this used element is sent in the bitstream 301.

Step 4: A residue block is formed by subtracting the input CU block with the predictor block. The residue block is encoded and transmitted in the bitstream 301.

### Embodiment 9

In this embodiment, Step 1 from embodiment 7 is modified so that value P₀(j) is calculated using the median pixel value of the j^{th} block.

### Embodiment 10

In this embodiment, Step 1 from embodiment 7 is modified so that value P₀(j) is calculated using the average of all the pixels in the j^{th} block.

### Embodiment 11

In this embodiment, Step 1 from embodiment 7 is modified so that value P₀(j) is equal to the value of the pixel from a specified location in the j^{th} block. But when the specified location is out of the picture boundary, an alternative value is used, e.g. the value of the pixel from the top-left corner, the average of the available pixel values in the boundary block, etc.

### Embodiment 12

In this embodiment, Step 1 from embodiment 7 is modified so that elements of set S₁ are trained from the last encoded slice. During the coding process of the last slice, all the original pixels in the last slice are available. A histogram of pixel values is built for the original pixels in the last slice. The top K most frequently used pixel values in the last encoded slice are used to form the set S₁.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for decoding a bitstream, wherein the bitstream includes compressed pictures of a video, wherein each picture is comprised of one or more slices, and wherein each slice is comprised of one or more blocks of pixels, and each pixel has a value corresponding to a color, comprising, for each slice, the steps of:
obtaining a reduced number of colors corresponding to the slice, wherein each color is represented as a color triplet and the reduced number of colors is less than or equal to a number of colors in the slice;
determining, for each block, a prediction mode, wherein an independent uniform prediction mode is included in a candidate set of prediction modes;
generating, for each block, a predictor block, wherein all values of the predictor block have a uniform value according to a color index when the prediction mode is set as the independent uniform prediction mode; and
adding, in a summation process, the predictor block to a reconstructed residue block to form a decoded block as output, wherein the steps are performed in a decoder.

2. The method of claim 1, further comprising:
parsing the bitstream to obtain the total number of colors.

3. The method of claim 1, further comprising:
predefining the reduced number of colors at an encoder and a decoder.

4. The method of claim 1, further comprising:
parsing the bitstream to obtain the color triplet.

5. The method of claim 1, further comprising:
predefining the color triplets at an encoder and a decoder.

6. The method of claim 1, wherein a subset of the color triplets is predefined at an encoder and a decoder, and additional color triplets are signaled in the bitstream.

7. The method of claim 1, wherein the color triplet is (0, 0, 0) so that only the reconstructed residue block is the output.

8. The method of claim 1, further comprising:
parsing, from the bitstream, to obtain the color index.

9. The method of claim 1, wherein the total number of colors is 1, and further comprising:
inferring the color index.

10. The method of claim 1, further comprising:
selecting one or more color triplets from a set of previous color triplets in the bitstream, if a frequency of occurrence of the one or more color triplets is above a threshold; and
including the one or more color triplets in the of reduced number of colors.

11. The method of claim 1, wherein each color index is associated with a corresponding color triplet.

12. The method of claim 1, wherein the bitstream is encoded in an encoder, and further comprising, for each slice, the steps of:
determining the reduced number of colors corresponding to the slice, wherein each color is represented as the color triplet and the reduced number of colors is less than or equal to the number of colors in the slice;
signaling, in the bitstream, a number of the color triplets and values of the color triplets associated with the reduced number of colors;
determining, for each block, the prediction mode, wherein the independent uniform prediction mode is included in the candidate set of prediction modes;
generating, for each block, the predictor block, wherein all values of the predictor block have the uniform value according to the color index when the prediction mode is set as the independent uniform prediction mode; and
subtracting, in a subtraction process, the predictor block from the input block, to form a residue block as output.

13. The method of claim 12, further comprising:
computing a histogram of selected pixels in the slice to determine a number of the color triplets in the slice;
applying a threshold to the frequency of occurrence of each triplet; and
adding the color triplets having a frequency greater than the threshold to a reduced number of most frequently-occurring color triplets.

14. The method of claim 12, further comprising:
signaling in the bitstream the total number of color triplets contained in the reduced number of colors.

15. The method of claim 12, further comprising:
computing a histogram of medians of pixel values in one or more blocks in the slice to determine the number of the color triplets in the slice.

16. The method of claim 12, further comprising:
computing a histogram of average pixel values in one or more blocks in the slice to determine the number of the color triplets in the slice.

17. The method of claim 12, further comprising:
computing a histogram of pixel values for pixels at specified locations in one or more blocks in the slice to determine the number of the color triplets in the slice.

18. The method of claim 17, further comprising:
determining whether the specified locations are outside a boundary; and
specifying a predetermined alternative location if the specified locations are outside the boundary.

19. The method of claim 17, further comprising:
determining whether the specified locations are outside a boundary; and
using a combination of the values of pixels in the block that are within the boundary for computing of the histogram.

20. The method of claim 12, wherein the reduced number of colors corresponds to the colors contained in a previous slice.

21. The method of claim 1, wherein the reduced number of colors corresponds to a block, and each color is represented as a color triplet and the reduced number of colors is less than or equal to a number of colors in the block.
